(19) United States
(12) Patent Application Publication
(10) Pub. No.: US 2010/0212821 A1
(43) Pub. Date: Aug. 26, 2010

(54) SYSTEM AND METHOD FOR COLD FOIL RELIEF PRODUCTION

(75) Inventors: Eli Grinberg, Kfar Saba (IL); Kobi Bar, Kfar Saba (IL)

Correspondence Address: MINTZ, LEVIN, COHN, FERRIS, GLOVSKY AND POPEO, P.C, ONE FINANCIAL CENTER, BOSTON, MA, 02111, US

(73) Assignee: Scodix, Ltd., Rosh Hayyin (IL)

(21) Appl. No.: 12/721,234

(22) Filed: Mar. 10, 2010

Related U.S. Application Data
(63) Continuation-in-part of application No. PCT/IL2008/001269, filed on Sep. 22, 2008.
(60) Provisional application No. 60/960,269, filed on Sep. 24, 2007.

(51) Int. Cl. B29C 65/02; B32B 37/02; B32B 38/14; B32B 38/10; B29C 65/16

(52) U.S. Cl. 156/247; 156/307.7; 156/272.8; 156/275.5; 156/277; 156/580; 156/387; 156/379.6

(57) ABSTRACT

Disclosed are methods, systems, machines and products, including a method for producing foil relief. The method includes placing a foil on a curable adhesive deposited on a substrate when the curable adhesive is substantially non-tacky, and applying energy to the adhesive deposited on the substrate while pressing the foil to the adhesive to cause the adhesive to become tacky and to adhere to the foil. The adhesive becomes substantially fully cured prior to completion of the pressing of the foil to the adhesive deposited on the substrate. In some embodiments, the method may further include pre-curing the curable adhesive prior to placing the foil on the adhesive to initiate the curing process of the adhesive and manipulate a viscosity level of the adhesive, with the pre-cured adhesive remaining substantially non-tacky. The curable adhesive includes one or more of, for example, a radical type adhesive and/or a cationic adhesive.

### CROSS-REFERENCE TO RELATED APPLICATIONS

This application is a continuation-in-part application of International application No. PCT/IL08/001269, entitled “A System and Method for Cold Foil Relief Production”, and with an international filing date of Sep. 22, 2008, which in turn claims priority from provisional U.S. application Ser. No. 60/960,269, entitled “A System and Method for Cold Foil Relief Production” and filed Sep. 24, 2007, the contents of both of which are hereby incorporated by reference in their entireties.

### FIELD OF THE DISCLOSURE

The present disclosure is generally directed to a system and method for cold foil relief production.

### BACKGROUND

A number of patents disclose foils for printing on paper, plastic, metal and other substrates (see e.g., U.S. Pat. Nos. 4,717,615, 4,837,072, and 5,053,260). These technical solutions disclose foil image transfer by means of selective heating and pressing foil to printable substrates. Thermally sensitive adhesive is deposited on a side of the printing foil adjacent to the printable substrate. Pressed and heated areas of the foil become adhered. After removing a foil backing the areas that have undergone pressure and heat exposure remain on the substrate, whereas unexposed areas are removed with the foil backing.

U.S. Pat. No. 5,520,763 describes selective dispensing thermal sensitive adhesive over the printable substrate. A dry toner used in xerographic process and bonded to paper by fusing, becomes adhesive to foil being heated. A desired pattern is printed on paper by a xerographic method. Printing foil is then pressed to the paper and heated. The heating causes the printed toner to melt and become tacky. The foil sticks to the tacky toner.

When the foil backing is removed, foil detaches from the foil backing and adheres to the foiling adhesive to cover the areas of the image that are desired to have foil printed. Foils are generally metallic and are often used for special printing effects. U.S. Pat. Nos. 6,605,174 and 6,977,101 specify chemical compositions of xerographic toner used in foil printing.

U.S. Pat. No. 4,484,970 discloses a method of applying decorative foil coated with an adhesive and ink to a material to produce an article having portions bearing ink and other portions bearing the decorative foil. The method uses foil specially coated with an adhesive, as well as ink specially adapted to repel the adhesive.

U.S. Pat. No. 6,605,174 discloses a method for producing a printed image having a region that is foil printed. The method includes printing at least one region of the image with a toner, printing the region of the image to be foil-printed with a foiling adhesive that sticks to a foil on a printing foil, with the adhesive having a melting temperature lower than the melting temperature of the toner, and pressing the printing foil to the image and heating the printing foil to a temperature greater than the melting temperature of the foiling adhesive but less than the melting temperature of the toner. U.S. Pat. No. 4,196,033 discloses a process for producing decorative sheets having a thermosetting resin surface. The process includes, (1) forming a pattern on a paper for decorative use with an ink containing a vehicle resin and a curing inhibitor for a thermosetting resin, (2) impregnating the entire paper for decorative use including the pattern with the thermosetting resin to form an impregnated paper wherein a film of still uncured thermosetting resin is formed over the pattern, (3) assembling a laminated structure by superposing the impregnated paper on a base material that the surface of the paper bearing the pattern will become the outer surface, and further placing a planar shaping member on the paper, (4) subjecting the laminated structure to heating and pressing to cause the thermosetting resin at parts not contacted by the curing inhibitor in the pattern to cure, leaving the thermosetting resin contacted by the curing inhibitor in the pattern in still uncured state, and (5) peeling off the planar shaping member, under heat and after the termination of the pressing, to form concavities in the film of the thermosetting resin by removing at least some of the still uncured resin due to adhesion of the uncured resin to the planar shaping member thus peeled-off. The improvement achieved by the process includes, selecting for the vehicle resin in the ink a resin having releasability from the thermosetting resin and, prior to step (2), causing the vehicle resin in the pattern formed in step (1) to harden, whereby the still uncured resin after step (4) is substantially restricted to the parts of the thermosetting resin directly over the pattern, and in step (5) substantially all of said uncured resin is released from the hardened vehicle resin and adheres to the planar shaping member.

U.S. Pat. No. 4,866,539 discloses a foil printing apparatus controllable by a computer. The apparatus includes laser printing means connectable to the computer for printing a printed image on a media, and, foil transfer means controllable by the computer for automatically transferring foil from a web of material having a transferable foil thereon onto at least part of the printed image, the foil transfer means including a means for supporting the web of material, a heatable roller and a pressure means for bringing the printed image on the media into pressurized contact with the web against the heatable roller, the pressure means including a pressure roller and an actuator for urging the heatable roller and pressure roller towards each other, wherein the pressurized contact of the pressure roller against the heatable roller causes the foil on the web to transfer to at least part of the printed image on the media.

The above '174, '033 and '539 patents rely on heat produced as a byproduct of the printing process to activate the adhesive or resin, and on cooling to solidify the adhesion process.

PCT Publication WO 02/34521 discloses an apparatus for applying foil from a foil web to a substrate. The apparatus includes a printing station for printing the substrate with a curable adhesive in the areas to which foil is to be applied, a first adhesive activation station in which the adhesive on the substrate is initially partially activated, a second adhesive activation station in which the adhesive on the substrate is activated again to complete adhesive cure, and a nip between the first and second adhesive activation stations in which foil can be pressed against the partially activated adhesive, means for transporting the substrate from the printing station, past the first adhesive activation station, through the nip and past the second adhesive activation station and foil transport means for feeding foil to and from the nip. It additionally discloses a method of applying foil from a foil web to a substrate that includes the steps of printing the substrate with a curable adhesive in the areas to which foil is to be applied, subjecting the substrate to a first adhesive activation stage in which the adhesive is partially activated, passing the substrate and a foil web through a nip where the foil is pressed against the partially activated adhesive, separating the foil web from the substrate after leaving the nip and subjecting the substrate to a second adhesive activation stage to fully cure the adhesive. The succession of steps comprising the method includes partially curing the adhesive, thereby achieving a tacky surface that is brought into contact with the foil web by nipping means. In a subsequent step the foil web is separated from the substrate, such that on areas of the foil web that were pressed against the tacky surface during the nipping step remain attached to the substrate. Finally, the foil that became attached to the tacky surface is subjected to a second curing step in order to solidify the adhesion between said foil and the adhesive on the one hand, and the adhesive and the substrate on the other.

The disclosed prior art of PCT Publication WO 02/34521 relies on the first stage of curing in order to produce tackiness, such that once the nipping step is executed the areas of the web foil that come in contact with the tacky surface becomes firmly attached to it. However, once the subsequent step of separating the foil web is executed, a number of undesirable effects may occur, including: misalignment, displacement, stretching, tearing, lifting of the edges, or a combination thereof. Moreover, during the nipping step, the foil is prone to distortion due to the malleable nature of the adhesive.

Furthermore, the use of heating in the printing process is not suitable for a wide array of printable substrates such as plastic substrates due to the risk of heat induced deformation.

### SUMMARY

Described herein are methods, systems and machines for cold foil stamping onto a substrate using a curable adhesive, such that adhesion of the foil when applying the foil, as well as when peeling excess foil, does not rely solely on the tackiness surface of the adhesive.

In some embodiments, a foil stamping system (also referred to as a pressing machine) is provided that includes a printing device to inject a pattern composed of a layer of adhesive onto a substrate. When initially injected onto the substrate, the adhesive is non-tacky. A conveyer belt advances the adhesive-topped substrate towards the pressing section, optionally exposing it, en route to the pressing section, to energy (e.g., radiation) applied from an energy source, thus initiating the curing of said adhesive and manipulating the adhesive's viscosity. The pre-cured adhesive is still non-tacky at that point. The change that is achieved in the partial curing is the increase in the viscosity of the adhesive such that it is not distorted in a next pressing operation. The adhesive-topped substrate is nipped between one or more nipping rollers and, for example, the conveyer belt (or companion nipping rollers), such that the foil comes into contact with the non-tacky surface of the adhesive. Once contact has been achieved, the adhesive is subjected to a further application of energy from another one or more energy sources, for example, a second radiation source such as a UV source. Application of the energy from the other one or more energy sources causes the adhesive to undergo the remainder of the curing process to thus become tacky and then, after adhering to the substrate and/or the foil, to harden (or solidify). Accordingly, with the application of energy from the second set of one or more energy sources (generally located downstream from the nipping roller at the entrance to the pressing section), once the substrate has traversed the pressing section and has advanced past the exit nipping roller, the adhesive has hardened and the resultant structure includes the foil adhered to the hardened adhesive, which in turn is adhered to the substrate. The resultant structure may then be processed using a peeler to peel excess foil.

In some embodiments of present disclosure, the adhesive is selected from a group consisting of radical-type or cationic.

In some embodiments of the present disclosure, the energy sources may include one or more of, for example, an ultraviolet radiation source, an electron beam source, a laser source, a heating element, a non-coherent lamp, and/or a combination thereof.

In one aspect, a method for producing foil relief is disclosed. The method includes placing a foil on a curable adhesive deposited on a substrate when the curable adhesive is substantially non-tacky, and applying energy to the adhesive deposited on the substrate while pressing the foil to the adhesive to cause the adhesive to become tacky and to adhere to the foil. The adhesive becomes substantially fully cured prior to completion of the pressing of the foil to the adhesive deposited on the substrate.

Embodiments of the method may include any of the following features.

The method may further include pre-curing the curable adhesive prior to placing the foil on the adhesive deposited on the substrate to initiate the curing process of the adhesive and manipulate a viscosity level of the curable adhesive. The pre-cured adhesive may remain substantially non-tacky.

Pre-curing the curable adhesive to manipulate the viscosity level of the curable adhesive may include increasing the viscosity level of the curable adhesive. Pre-curing the curable adhesive may include pre-curing the curable adhesive such that an embossed shape of the curable adhesive is maintained subsequent to completion of the pre-curing.

Applying the energy may include applying energy from one or more of, for example, an ultraviolet radiation source, an electron beam device, a laser device, a non-coherent lamp and/or a heating element.

The method may further include depositing a layer of the curable adhesive on the substrate in a pre-determined pattern prior to the placing of the foil on the adhesive deposited on the substrate. Depositing the layer of the curable adhesive may include printing the layer of the curable adhesive patterns using on one or more of, for example, inkjet printing, toner-based printing, silk screen printing and/or lithography printing.

Placing the foil on the adhesive deposited on the substrate may include pressing the foil to the adhesive deposited on the substrate using one or more nipping rollers.

Pressing the foil to the adhesive deposited on the substrate using one or more nipping rollers may include pressing the foil to the adhesive deposited on the substrate using a first set of nipping rollers when the adhesive is substantially non-tacky, and pressing the foil to the cured adhesive deposited on the substrate using a second set of nipping rollers after applying the energy.

The method may further include peeling excess foil.

The curable adhesive includes one or more of, for example, a radical type adhesive and/or a cationic adhesive.

The substrate is made from a material selected from the group of materials consisting of for example, methacrylic copolymer resin, polyester, polycarbonate and/or polyvinyl chloride.

The method may further include increasing flexibility of the foil being placed on the adhesive deposited on the substrate by performing one or more of, for example, actuating multiple nip rollers used to press the foil to the adhesive deposited on the substrate to move at different rotational speeds and/or applying pressure to the foil.

Placing the foil on the adhesive deposited on the substrate may include pressing one or more different foils to respective adhesive layers deposited on one or more substrates using multiple adjacent nipping rollers aligned along respective longitudinal axes of the multiple nipping rollers.

In another aspect, a system for foil relief production is disclosed. The system includes a pressing machine to press foil to a curable adhesive deposited on a substrate received at an entry stage of the pressing machine when the curable adhesive is substantially non-tacky, and one or more energy sources to apply energy to the foil pressed to the curable adhesive deposited on the substrate to cause the adhesive to become tacky and adhere to the foil. The adhesive becomes substantially fully cured prior to the removal of the foil adhered to the substrate from an exit stage of the pressing machine.

Embodiments of the system may include one or more of the above-described features of the method, as well as any of the following features.

The system may further include another energy source to apply energy to pre-cure the curable adhesive prior to delivering the curable adhesive deposited on the substrate to the entry stage of the pressing machine, the other energy source configured to initiate the curing process of the adhesive and manipulate a viscosity level of the curable adhesive, the pre-cured adhesive remaining substantially non-tacky.

The other energy source configured to manipulate the viscosity level of the curable adhesive may be configured to increase the viscosity level of the curable adhesive.

The other energy source configured to initiate the curing process of the adhesive and manipulate the viscosity level of the curable adhesive may be further configured to cause an embossed shape of the curable adhesive to be maintained after completion of the pre-cure operation.

The system may further include a printing device to deposit a pre-determined pattern of the curable adhesive on the substrate.

The printing device includes one or more of for example, an inkjet printer, a toner-based printer, a silk screen printer and/or a lithography-based printer.

The pressing machine may include one or more nipping rollers to press the foil against the curable adhesive deposited on the substrate.

The one more nipping rollers may include a first set of nipping roller positioned proximate to the entry stage of the machine to press the foil to the adhesive deposited on the substrate when the adhesive is substantially non-tacky, and a second set of nipping rollers positioned proximate to the exit stage of the machine to press the foil to the cured adhesive deposited on the substrate after application of energy by the one or more energy sources.

The system may further include a conveyor belt to move the substrate having the curable adhesive deposited on it through the pressing machine.

The system may further include a peeler to peel off excess foil not adhered to any portion of the cured adhesive.

In a further aspect, a system for the production of foil relief is disclosed. The system includes an integrated nipping-curing system receiving a substrate topped with a patterned layer of curable adhesive, the curable adhesive being non-tacky, the integrated system including, i) means for simultaneously nipping and foil dispensing, ii) a first radiation emitting means adapted for causing the adhesive to become tacky and for fully curing the foiled and nipped adhesive, located upstream of the end of the nipping means, and iii) means for peeling excess foil from adhesive-free surfaces of the cured substrate. The peeling means is downstream of the full-curing radiation emitting means.

Embodiments of the system may include one or more of the above-described features of the method and/or of the first system, as well as any of the following features.

The radiation emitting means may be selected from a group consisting of, for example, ultraviolet radiation, electron beam, and/or a combination thereof.

The foil may include a foil layer and a foil backing layer.

The system may additionally include least one second radiation emitting means, upstream of the nipping means, adapted for one or more of, for example, pre-curing and/or initiating the curable adhesive.

The first radiation emitting means may be configured to emit radiation equal to, or greater than, radiation emitted by the second radiation emitting means.

The system may additionally include a printing means adapted to top the substrate with the at least one patterned layer of curable adhesive.

The printing means may be selected from a group consisting of, for example, inkjet, toner, silk screen printing, lithography printing, flexographic printing, and/or a combination thereof.

The adhesive may have an initial viscosity of about 10 cps.

The layer of adhesive may have a thickness of about 4 to 150 microns.

The system may additionally include a conveyer belt, adapted to advance the substrate through the means for simultaneously nipping and foil dispensing.

The system may additionally include a conveyer belt, adapted to advance the substrate through the peeling means.

The means for simultaneously nipping and foil dispensing may include at least two nipping rollers.

The distance between the at least two nipping rollers may be at least the length of one dimension of the substrate.

The first radiation emitting device may be located upstream of one of the nipping rollers and downstream of at least one of the nipping rollers.

The nipping means may include at least one bottom nipping roller and at least one top nipping roller.

In yet another aspect, a method for applying foil onto a substrate is disclosed. The method includes providing a system for the production of foil relief that includes an integrated nipping-curing system receiving a substrate topped with a patterned layer of curable adhesive, the adhesive being substantially non-tacky when received by the integrated nipping-curing system, and means for peeling excess foil from adhesive-free surfaces of the cured substrate. The method also includes traversing the adhesive topped substrate through the nipping system, nipping the foil and the substrate thereby bringing the foil into contact with the top side of the adhesive topped substrate, curing the adhesive substantially fully, solidifying the adhesion of the foil to the patterned layer of curable adhesive, peeling the excess of the foil, by peeling foil away from surfaces upon the substrate that have not been patterned with the layer of adhesive, and producing a relief of foil upon the substrate. Curing the adhesive substantially fully is performed prior to the peeling.

Embodiments of the method may include one or more of the above-described features of the first method and/or of the systems, as well as any of the following features.

The method may additionally include a step of applying the patterned layer of adhesive to the substrate.

The method may additionally include a step, performed upstream of the nipping step, of pre-curing or otherwise initiating the curing of the adhesive.

The method may additionally include a step of repeating the step of applying the patterned layer of adhesive to the substrate, in order to achieve thickness of the layer of up to about 4 to 150 microns.

In an additional aspect, a foil printing mechanism is disclosed. The mechanism is adapted for selective adhesion of foil to substrate.

Embodiments of the printing mechanism may include one or more of the above-described features of the methods and/or of the systems, as well as any of the following features.

The printing mechanism may include a) a substrate feeder, b) a foil feeder, c) means for selectively dispensing adhesive over the substrate, d) means for pressing the foil to the substrate, and e) means for peeling the foil, such that only portions of metallic layer that have come into contact with the adhesive remain attached to the substrate. The dispensing means is adapted to dispense the adhesive fluid, in fine droplet form of about 20-150 microns, according to a desired pattern. The adhesive is substantially non-tacky when received by the means for pressing. And the pressed foil and substrate become substantially fully cured prior to being processed by the means for peeling.

The printing foil may include a foil backing consisting of a detachable structural support layer and/or a metallic layer.

The substrate is formed from a material selected from the group of materials consisting of, for example, methacrylic copolymer resin, polyester, polycarbonate and/or polyvinyl chloride.

The substrate is physically characterized by a form or material composition selected from a group consisting of, for example, sheet form, roll form, rigid, flexible, metal, plastic, paper, glass, non-woven fabric, methacrylic copolymer resin, polyester, polycarbonate and/or polyvinyl chloride.

In another aspect, a foil printed pattern is disclosed. The foil printed pattern includes a) a substrate, b) an adhesive layer selectively dispensed on a surface of the substrate, and c) a metal layer transferred from foil backing. The adhesive layer is dispensed by fine droplets of about 40-150 microns, in accordance with the pattern. The adhesive is substantially non-tacky when the metal layer is transferred, and the foil printed pattern becomes substantially fully cured during pressing of the metal layer to the adhesive-topped substrate.

Embodiments of the foil print pattern may include one or more of the above-described features of the methods, the systems and/or the printing mechanism.

In a further aspect, a method for printing a pattern on a printable substrate using a printing foil including a foil backing, releasable layer and a metal layer is disclosed. The method includes providing a printing mechanism comprising i) a substrate feeder, ii) a foil feeder, iii) means for selectively dispensing adhesive over the substrate, iv) means for pressing the foil to the substrate, and v) means peeling the foil, such that only portions of metallic layer that have come into contact with the adhesive remain attached to the substrate. The method also includes providing a substrate, providing foil, dispensing the adhesive in a selective pattern upon the substrate, nipping the foil to the substrate and the foil, selective dispensing of adhesive over portions of the substrate, nipping the substrate and the foil together, and peeling the foil from the adhesive free portions of the substrate. The step of dispensing the adhesive fluid is performed selectively in fine droplet form according to a desired pattern. The adhesive is substantially non-tacky when nipping the substrate and the foil together. And the nipped substrate and foil are substantially fully cured prior to the peeling.

Embodiments of the method may include one or more of the above-described features of the methods, the systems, the printing mechanism and/or the foil printed pattern.

### BRIEF DESCRIPTION OF THE DRAWINGS

To better understand the disclosure and its implementations in practice, embodiments will now be described, by way of non-limiting examples only, with reference to the accompanying drawings.

FIG. 1 is a schematic diagram of a system to perform conventional cold foil stamping.

FIG. 2 is a schematic diagram of an example embodiment of a cold foil stamping system according to embodiments described herein.

FIG. 3 is a schematic diagram of a pressing section, shown in the system of FIG. 1, illustrating the stretching effect caused to the foil-adhesive-substrate structure when processed by a system such as the system of FIG. 1.

FIG. 4 is a schematic diagram of a portion of the system of FIG. 2 configured to avoid stretching/warping effects during cold foil stamping.

FIGS. 5a and 5b are views of processed relief structures obtained using the systems of FIGS. 2 and 1, respectively.

FIG. 6 is a flowchart of a foil relief production procedure.

FIG. 7 is a schematic diagram of a pressing section/machine that includes one or more energy sources to apply energy to a foil to make it more flexible, and a pressure applying machine.

FIG. 8 is a schematic diagram of an example implementation of a pressing machine to place foil on a curable adhesive deposited on a substrate.

FIG. 9a-b are schematic views of a nip rolling assembly.

Like reference symbols in the various drawings indicate like elements.

### DETAILED DESCRIPTION

Disclosed are methods, systems, machines and devices, including a method for producing foil relief. The method includes placing a foil on a curable adhesive deposited on a substrate when the curable adhesive is substantially non-tacky (i.e., before it has become tacky as a result, for example, of a curing process performed via application of energy). The method further includes applying energy to the arrangement of the foil placed on the substantially non-tacky adhesive, while the foil is being pressed onto the adhesive and substrate arrangement, to cause the adhesive to become tacky and to adhere to the foil. The adhesive becomes substantially fully cured prior to completion of the pressing of the foil to the substrate. In some embodiments, the curable adhesive can include, for example, a radical type adhesive, a cationic adhesive, etc.

In the present disclosure, the terms below are defined as follows:

The term ‘Inkjet Printing’ or ‘Inkjetting’ refers hereinafter to an adaptation of the conventional technology developed for the deposition of ink onto paper, including: thermal inkjets, piezoelectric inkjets and continuous inkjets, as the devices for the deposition of various materials in liquid form, including adhesive, onto a substrate.

The term ‘foil’ refers to film or sheet of any material having, for example, about 1 microns to about 200 microns in thickness. In some embodiments, such a material may be a metallic material, such as, for example, tin, aluminum, etc. Sometimes, such foil is referred to as ‘cold foil’.

The term ‘nipping’ refers to the action of holding and/or squeezing at least two items together.

The term ‘curing’ refers to the toughening or hardening of a polymer material by a process of, for example, cross-linking of polymer chains, brought about by a an energy application mechanism that includes, for example, chemical additives, ultraviolet radiation, electron beam (EB), heat application, etc.

The term ‘foil backing’ refers to a layer of detachable material that provides structural support for the foil.

The term ‘relief’ refers to a pattern or modeled form that is raised (or alternatively lowered) from a flattened background.

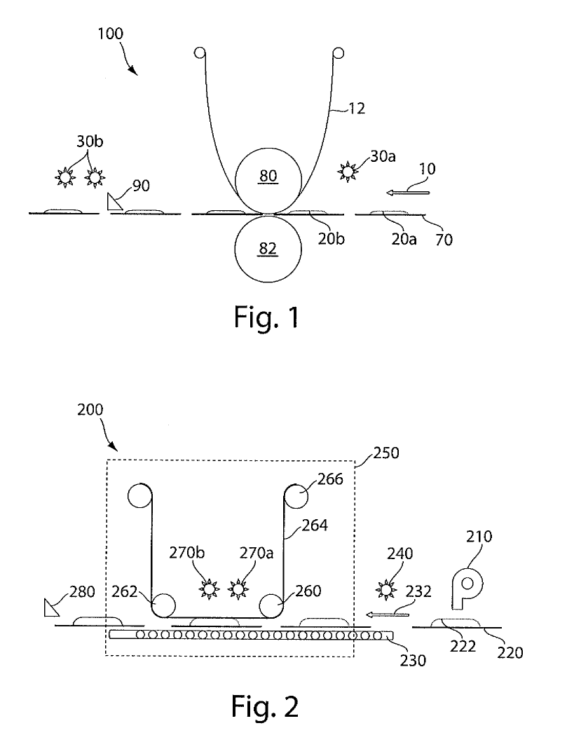

Reference is made now to FIG. 1 illustrating a conventional cold foil stamping system 100. As shown, a pattern of curable adhesive 20a is printed (deposited) on a substrate 70 using a printing device (not shown). The patterned curable adhesive generally has a thin layer of about 3 to 60 microns of curable adhesive that is initially non-tacky. The substrate 70 on which the curable adhesive is printed is advanced by a conventional transporting mechanism (e.g., a conveyor belt) in a direction indicated by an arrow 10. En route to the pressing part of the system 100, the adhesive is exposed to radiation emitted from an energy source 30a (e.g., a radiation source, such as, for example, a ultraviolet source) thus initiating the curing of the adhesive and causing the adhesive to become tacky (the tacky adhesive being marked as 20b). The substrate 70 topped with the now tacky pattern of the adhesive 20b is pressed against foil 12 as the foil and the adhesive deposited on the substrate pass between nipping rollers 80 and 82. Once the substrate 70 emerges from the nip of the rollers, the foil clings to the tacky surface. Subsequently, excess foil is peeled away by a foil peeler 90. The resultant “sandwich” structure comprising the substrate topped with the tacky adhesive and further topped with the trimmed foil that has clung to the patterned adhesive is subjected to radiation from a radiation source 30b for completion of the curing of the adhesive and solidification of the structure. In some situations, the peeling of excess foil in conventional systems occurs before the “sandwich” structure has become fully solidified, thus resulting in further distortion/warping of the structure when processed by the peeler.

With reference to FIG. 2, a schematic diagram of a pressing system 200 to press foil onto non-tacky adhesive is shown. The system 200 includes a pressing section 250 (also referred to as a pressing machine) to press foil into a substrate-and-adhesive structure it receives from a printing section located upstream of the pressing section. The printing section includes a printing device 210 (e.g., an inkjet printer) to inject a pattern of deposit composed of a layer of adhesive 222, generally having a thickness of about 1 to 200 microns, onto a top surface of a substrate 220. Other types of printing devices that may be used include, for example, a toner-based printer, a silk screen printer, a lithography-based printer, etc. When deposited on the substrate 220, the adhesive layer 222 is generally non-tacky. A conveyer belt 230 advances the adhesive-topped substrate (which, as noted, may be patterned) in a direction indicated by an arrow 232.

The curable adhesive used is one which may be pre-cured to commence the curing process, but without causing the adhesive to become tacky. Pre-curing of the adhesive may be such that the embossed shape of the curable adhesive is maintained subsequent to the completion of the pre-curing operation. After the pressing of a foil on the substrate having the patterned adhesive, the adhesive is cured to cause it to become substantially tacky and thus to cause the foil, adhesive and substrate materials to adhere to each other. The adhesive becomes substantially fully cured prior to completion of the pressing of the foil to the adhesive 222 deposited on the substrate 220. In some embodiments, the adhesive may include a radical type adhesive, a cationic adhesive, etc. Such adhesives may include, for example, photo polymeric adhesives.

The substrate 220 may be constructed from a material composition including, for example, metal, plastic, paper, glass, non-woven fabric, methacrylic copolymer resin, polyester, polycarbonate and polyvinyl chloride, plastic, paper, glass, non-woven fabric, methacrylic copolymer resin, polyester, polycarbonate, polyvinyl chloride, etc. The substrate 220 may be in sheet form or roll form and may be rigid or flexible.

In some embodiments, the structure comprising the substrate 220 and the curable adhesive 222 (in its non-tacky form) may be exposed to energy applied from a first, optional, energy source 240 located upstream (i.e., before) of a nip roller 260 en route to the pressing section 250 of the system 200, thus initiating the curing of the adhesive 222 and manipulating (regulating) the adhesive's viscosity. In some embodiments, the adhesive has an initial viscosity of 10 cps (centipoise). In some embodiments, the energy source 240 may be a radiation source, such as a ultraviolet source, emitting UV radiation onto the curable adhesive 222 to initiate the curing process. Partial curing performed on the adhesive, e.g., to initiate the curing, causes the polymerization of the material to start so that the adhesive starts to changes its phase from liquid to solid. In some embodiments, the energy source 240 may be, for example, a lamp generating incoherent optical radiation, a laser source, an electron beam generator, a heating element, etc. Other types of energy sources may be used.

The energy applied to the adhesive is generally not sufficient to cause the adhesive to become tacky, but instead is used to cause the adhesive to achieve a form or state of higher viscosity such that upon further exposure to energy (e.g., from energy sources 270a and/or 270b), the adhesive will achieve a tacky form more quickly than it would have without the exposure to the energy source 240. The use of an energy source to initiate the curing process prior to arriving at the pressing machine may thus expedite the pressing process.

The structure including the adhesive-topped substrate (with or without having the adhesive 222 exposed to the upstream energy source 240 to initiate the curing process) passes through the pressing section that includes nipping rollers 260 and 262. In some embodiments, the distance between the nipping roller 260 and the nipping roller 262 (or between a roller set that includes the roller 260 and a second roller set that includes the roller 262) is at least the length of one dimension of the substrate 220. Once the adhesive-topped substrate passes by the nipping roller 260 (as depicted in FIG. 2, the adhesive-topped substrate passes underneath the nipping roller 260), a section of a foil web 264 comes into contact with the still non-tacky surface of the adhesive 222. The foil web 264 may be fed by a spool 266 or may be pulled by the nipping roller 260. The nipping rollers (also referred to as pinching rollers) are configured to exert force on the foil passing under the nip rollers and the substrate-adhesive structure. In some implementations, the nipping operations may be performed using opposite facing rollers (in a manner similar to that depicted in FIG. 1), such that, for example, the substrate-adhesive-foil materials would be pressed together by the nipping roller 260 and another roller facing the roller 260, and subsequently would be pressed by the nipping roller 262 and possibly a further roller opposite-facing the roller 262.

Once the contact between that section of the foil and the still non-tacky surface of the adhesive on the substrate 220 has been made, the adhesive 222 is subjected to energy from the second one or more energy sources 270a and 270b (which, like the energy source 240, each may be a radiation source, a heat source, etc.) to perform the curing process of the adhesive 222 to thus cause the adhesive 222 to become tacky. As depicted in FIG. 2, in some implementations, the one or more energy sources 270 include two energy sources (e.g., arranged to define an array of energy sources) that may be arranged in configurations to enable particular energy distribution patterns.

In some implementations, a suitable adhesive that may be used is a radical-free glue that upon exposure to energy (e.g., UV radiation) with an energy level of, for example, about 5-15% of the energy output of the radiation sources used in the system 200, causes the adhesive to become more viscous, and to turn into a jelly-like material, but without the adhesive becoming tacky. The exposure of the adhesive to that level of energy can thus perform the pre-curing of the adhesive that will subsequently enable a more expeditious curing and pressing processes required to perform the cold foil relief procedure. Subsequently, the energy level applied during the pressing stage may be 85-95% of the aggregate of applied energy. For example, in some implementations, the total energy output required from the energy sources of the system 200 (e.g., the energy source 240, the energy sources 270a and 270b, and any other source that may be used in such implementations) to perform the entire curing process (i.e., the pre-curing and the remainder of the curing process) may be, for example, approximately 300 W. Under those circumstances, where pre-curing energy is implemented, 10% of the total energy may be applied by the energy source 240 for a power level of 30 W to initiate the curing process (i.e., to cause the pre-curing of the adhesive), while one or more energy sources 270a and 270b are configured to apply energy corresponding to 90% of the total energy exposure, or approximately 270 W, to cause the adhesive to become tacky and adhere to the foil and substrate, and to subsequently solidify the adhered multi-layer structure of the foil, adhesive and substrate. As noted, the curing process, and thus the solidification (hardening) of the adhesive is completed prior to the resultant structure exiting the pressing section, and therefore any peeling of excess foil on the resultant structure is performed with curing processing having been completed (and accordingly, with the adhesive having been solidified).

In some embodiments, the level of energy applied at the various stages of the system 200 may be based, at least in part, on the nature/composition of the adhesive material, the speed at which the substrate and adhesive deposited thereon are advancing through the various stages of the system 200, etc. Also affecting the energy levels that are to be used during the pre-curing and/or the curing process are the characteristics of the foil material, including the foil material's energy permeability. For example, in circumstances where the energy source is a radiation source, such as a UV source, the level of energy that needs to be applied to the foil so that enough of the applied energy will reach the adhesive and interact therewith may depend on the optical permeability of the foil, which may represented by the foil's optical density. The optical density, or OD, is a measure of the extent to which a material, in this case the foil 264, transmits light or other electromagnetic radiation. The OD may be defined according to log I₀/I, where I₀ is the intensity of the radiation on the foil, and I is the intensity of the radiation that permeates the foil and is transmitted from its opposite surface onto the adhesive. A suitable foil material that may be used to perform the cold foil relief described herein may be a foil having and optical density of, for example, 0.8-1.2.

Once the substrate has traversed the pressing section and has emerges passed the nipping roller set 262, the adhesion of the foil to the substrate 220 is substantially completed with the adhesive 222 becoming substantially solidified. A peeler 280 may then be used to peel excess foil from the substrate.

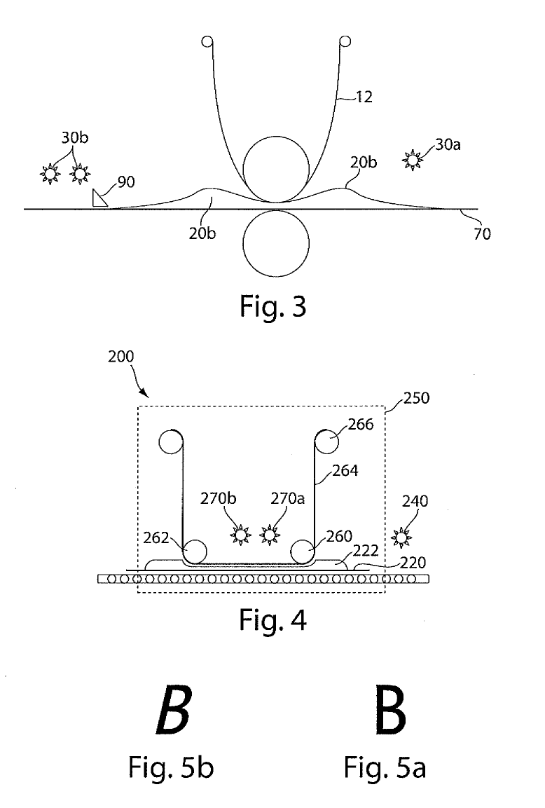

With reference to FIG. 3, a schematic view of a portion of the system 100 of FIG. 1 is shown, in which the stretching, or warping, effect of a resultant foil pressed against a substrate with a curable adhesive deposited on it is depicted. Particularly, as described herein, in the conventional system 100 of FIG. 1, the adhesive layer 20 deposited on the substrate 70 is subjected to energy from an energy source 30a that causes the adhesive to become tacky. The pressing of the foil 12 on the tacky adhesive layer 20 results in some warping of the foil's surface, causing surface irregularities of the foil's surface. Furthermore, when the resultant structure comprising the foil placed on the adhesive layer deposited on the substrate 70 exits the pressing section of the system 100, the adhesive has generally not completely solidified at that point. Thus, the distortion (warping) of the foil's surface on the substrate is exacerbated when peeling excess foil before the completion of the solidification of the adhesion between the foil 12 and the substrate 70. Such solidification of the adhesive layer is generally accomplished by the ensuing application of energy by the energy source 30b located downstream of the exit of the pressing section (and in the configuration of system 100 as depicted in FIG. 3, is also located downstream from the peeler 90.)

In contrast to the warping that can occur by using system arrangements such as the system 100, FIG. 4 illustrates a schematic diagram of part of the system 200 shown in FIG. 2 that can avoid the stretching/warping effects caused by, for example, the system 100. As described herein, the substrate 220 topped with the adhesive 222 arrives at the entrance to the pressing section 250 with the curable adhesive generally being non-tacky. As noted, in some embodiments, pre-curing may be performed on the adhesive 222, for example, using the optional energy source 240, to put the adhesive in a condition in which further application of energy would cause the adhesive to become tacky. The substrate 220 and the adhesive 222 topped thereon are nipped to foil 264 using, for example, the nip roller 260. At that point, the adhesive is not yet tacky, and thus, minimal (if any) stretching or warping of the foil placed on the adhesive layer 222 occurs. As the structure of the foil placed on the adhesive layer 222 deposited on the substrate 220 advances through the pressing section 250 of the system 200, the one or more energy sources 270a and 270b apply energy (e.g., UV radiation) onto the foil-adhesive-substrate structure, and as a result the adhesive undergoes the curing process; first becoming tacky and adhering to the section of the foil 264 and to the substrate 220, and subsequently solidifying (hardening) to form a stable structure. When the structure comprising the foil on top of the now cured adhesive deposited on the substrate 220 emerges from the exit of the pressing stage (past the nip roller 262) the structure has generally solidified with minimal (if any) resulting stretching or warping of the foil on top of the cured adhesive layer. The generally cured structure is now processed by the peeler (not shown in FIG. 4) to peel excess foil.

With references to FIGS. 5a and 5b, views of processed relief structures obtained using the systems 200 and 100, respectively, are shown. The effect of stretching distortion of foil stamped script (the letter B) is illustrated in FIG. 5b, whereas the unwarped cold foil printing achieved using the system 200, in which the foil was placed on a non-tacky adhesive prior to commencing of the curing process, and in which the curing process was completed during the pressing process, is illustrated.

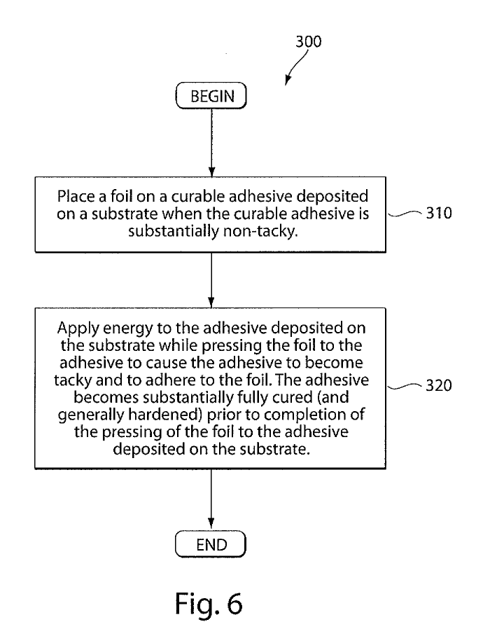

With reference to FIG. 6, a flowchart of a foil relief production procedure 300 is shown. Initially, a curable adhesive is deposited, for example, using a printing device, on a substrate. The curable adhesive may be, for example, one or more of a radical type adhesive, a cationic adhesive, etc. A foil is then placed 310 on the adhesive deposited on the substrate using, for example, a first nip roller set that exerts force on the foil passing underneath it. At the point when the foil is placed on the adhesive, the adhesive is not tacky. In some embodiments, prior to placing the foil on the non-tacky adhesive, a pre-curing of the adhesive, e.g., using an energy source placed upstream of the first nip roller set, to initiate the curing process (but without making the adhesive tacky) is performed so that upon subsequent application of energy, the adhesive would more quickly become tacky.

Having placed the foil on the adhesive-topped substrate, energy is applied 320 to the adhesive while pressing the foil to the adhesive deposited on the substrate (e.g., using the nip roller) to cause the adhesive to become tacky and cause it to adhere to the foil. The adhesive becomes substantially fully cured (and generally hardened) prior to completion of the pressing of the foil to the adhesive deposited on the substrate, and thus prior to peeling any excess foil from the resultant solidified foil-adhesive-substrate structure.

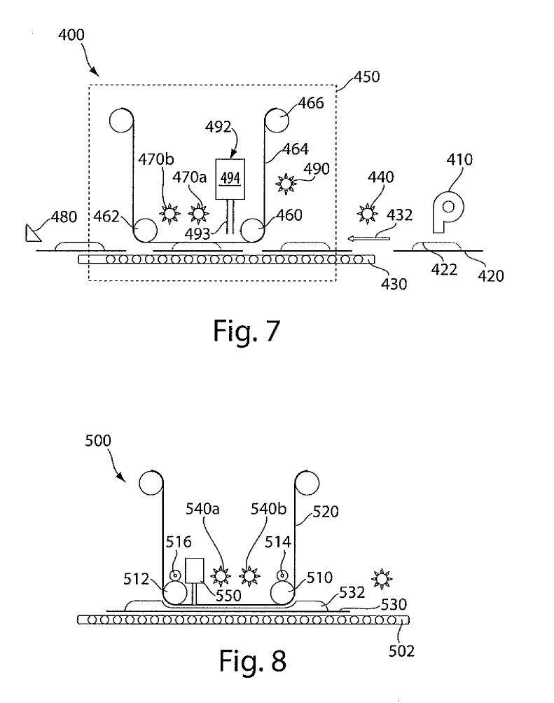

With reference now to FIG. 7, a schematic diagram of a pressing system 400 is shown. The pressing system 400 is generally similar to the system 200 depicted in FIG. 2, and is thus generally configured to perform similar operations to those performed by the system 200. As such, the system 400 includes a printing device 410 that may be similar to the printing device 210 and may include, for example, one or more of an ink jet, a toner-based printer, a silk screen printer, a lithography-based printer, etc. The printing device is configured to print (or deposit) a patterned layered of curable adhesive 422, having a composition that may be similar to the adhesive 222 of FIG. 2, on top of a substrate 420 (which may be similar to any of the substrate materials that may be used in conjunction with the system 200). An optional energy source 440 may be operated to apply energy onto the layered adhesive on top of the substrate 420 to cause the adhesive to become pre-cured, but without causing it become tacky. When the substrate-topped-adhesive enters the entrance of the printing section 450, a section of a foil web 464 is pressed against the non-tacky adhesive using, for example, the nip roller 460. As the substrate-adhesive-foil structure continues to advance (in a direction indicated by the arrow 432) through the pressing section (via, for example, a conveyor belt 430 which may be similar to the conveyor belt 230), it is subjected to energy from one or more energy sources 470a and 470b (which may be similar to any of the energy sources 240, 270a, 270b and 440 described herein). The energy, which in some embodiments, permeates through the foil placed on the adhesive, causes the adhesive 422 to undergo the curing process during which the adhesive becomes tacky and adheres to the foil and/or the substrate. The curing performed during the pressing also causes the substantial solidification of the foil-adhesive-substrate structure prior to the completion of the pressing (i.e., before the foil-adhesive-substrate structure exits the pressing section at the nip roller 462 and/or before peeling of excess foil is performed using a peeler 480).

As further shown in FIG. 7, optionally, in some embodiments, another energy source 490 may be positioned proximate to the foil web 464, and may be configured to apply energy to the foil web 464 generally before the energized web comes in contact with the adhesive on top of the substrate entering the pressing section 450. The energy source 490 is configured to apply energy to the foil web 464 at a sufficient level to cause the foil to become more flexible. The higher achieved flexibility of the foil 464 enables better contact with the adhesive layer 422 when the heated foil is placed/pressed by, for example, the nip roller 460. In some embodiments, the energy source 490 may be positioned between a spool 466 and the nip roller 460 at a distance sufficient to apply energy to the foil. The energy source 490 may be similar to any of the energy sources 440, 470a and 470, and may include, for example, a UV source, a lamp generating incoherent optical radiation, a laser source, an electron beam generator, a heating element, etc. Other types of energy sources may be used.

While FIG. 7 depicts only one energy source, additional optional energy sources to apply energy to the foil to control the flexibility and/or other of the materials' properties (e.g., elasticity, malleability, etc.) may be used. The energy source 490 and/or other optional energy sources that control properties of the foil may be arranged using different configurations to achieve various desirable energy distributions on the foil to thus further control the properties of the foil, and by extension, control the placement of the foil on the adhesive, as well as the resultant structure that exits the pressing section of the system 400 (e.g., additional energy sources may be placed along the path followed by the foil to control the temperature, flexibility and other properties of the foil and/or other materials, in some pre-determined manner). Furthermore, the use of energy sources to control properties of the foil, e.g., the foil's flexibility, may also be implemented in other types of systems in which foil, such as the foil shown in FIGS. 2 and 4 is used, and not only with respect to the systems 200 and/or 400.

In some implementations, the foil web can be made more flexible by reducing the web's tension (i.e., causing it to become more slack) by applying different levels of torque at different locations along the advancing web. With reference to FIG. 8, a schematic diagram of an example implementation of a pressing system/machine 500 to place foil on a curable adhesive deposited on a substrate is shown. The machine 500 includes nip rollers 510 and 512 configured to apply force to a foil web 520 contacting the nip rollers to place the web onto an adhesive layer 532 deposited on a substrate 530 that is being advanced (e.g., using a conveyor belt 502) through the pressing system. Curing of the adhesive layer may be performed by one or more energy sources 540a and 540b, which may be similar to any of the energy sources depicted, for example, in FIGS. 2, 4 and 7.

One or more of the nip rollers 510 and/or 512 is actuated by a driving mechanism such as auxiliary rollers 514 and 516 that may each be actuated by associated respective motors (not shown) to transfer rotational motion to the auxiliary rollers. As the auxiliary rollers 514 and 516 rotate, they in turn transfer rotational motion (torque) to their respective nip rollers. By controlling the respective rotation speeds (angular speeds) of the auxiliary rollers, the tension of the foil web 520 may be controlled. Particularly, by controlling the rotational speeds of the auxiliary rollers, the nip rollers 510 and 512 may be actuated to rotate at different speeds. As a result of the different rotational speeds at which the nip rollers 510 and 512 are rotating (for example, the nip roller 510 can be actuated to rotate at a higher speed than the nip roller 512) the tension in the foil web is reduced, and the foil web 520 obtains more slack, thus reducing stretching/warping effect depicted, for example, in FIG. 3.

In some embodiments, a feedback mechanism 550 may be used to determine the tension of the foil web placed between the two nip rollers 510 and 512, and control the motors actuating the auxiliary rotors 514 and 516 based on the measured tension so as to increase or decrease the rotational speeds of either of the nip rollers 510 and/or 512. In some embodiments, the tension of the foil web can be determined based on the measured power consumed by the driving motor (i.e., the power consumed may be proportional to the tension of the foil in a manner that can determined through, for example, a calibration procedure). If it is determined that the tension in the web is too high, the feedback mechanism can control the auxiliary roller 514 control signal to cause the roller to increase its rotational speed, which in turn will cause the nip roller 510 to increase its rotational speed and thus cause the tension in the foil web to decrease.

It should be noted that the positioning of the auxiliary rollers depicted in FIG. 8 as being underneath the nip rollers 510 and 512 is by example only, and that the auxiliary rollers can be positioned in other locations in the arrangement that includes the nip rollers 510 and 512. In some embodiments, the nip rollers may be directly coupled to motors that actuate the nip rollers to control their rotational speeds. Additionally, other types of driving mechanisms may be used to control the motion of the nip rollers and by extension the level of tension in the foil. Furthermore, the use of a driving mechanism to facilitate controlling foil tension may also be implemented in other types of systems in which foil, such as the foil shown in FIGS. 2, 4, 7 and 8 is used, and not only with respect to the systems 200, 400 and/or 500.

Turning back to FIG. 7, in some embodiments, the system 400 may also include a pressure device 492 configured to direct air, or some other gases or fluids, at the foil, to controllably press the foil onto the adhesive being cured. The air pressure device includes a conduit 493, such as a pipe or a hose, connected at one end to an air source 494 (e.g., a pump or a high pressure tank) that directs air through the conduit 493 to the conduit's distal outlet. The conduit's outlet is positioned, for example, over the foil, and thus the application of the pressurized gas or liquid over the foil during the curing of the adhesive 422 (as the adhesive is becoming tacky and subsequently is hardening) causes controllable level of force to be applied to the foil to thus improve the contact between the foil and the adhesive undergoing the curing process. In some embodiments, other types of devices to cause a controlled application of force on the foil to improve contact between the foil, adhesive and the substrate may be employed. Although one air pressure device is shown in FIG. 7, additional similar devices (and/or other types of force creating devices) may be used, and positioned along different points in the pressing section 450, or elsewhere. Furthermore, here too, the use of force application devices to improve contact between the foil and the underlying adhesive layer and the substrate on which it is deposited may also be implemented in other types of systems in which foil, such as the foil shown in FIGS. 2 and 4, is used, and not only with respect to the systems 200 and/or 400.

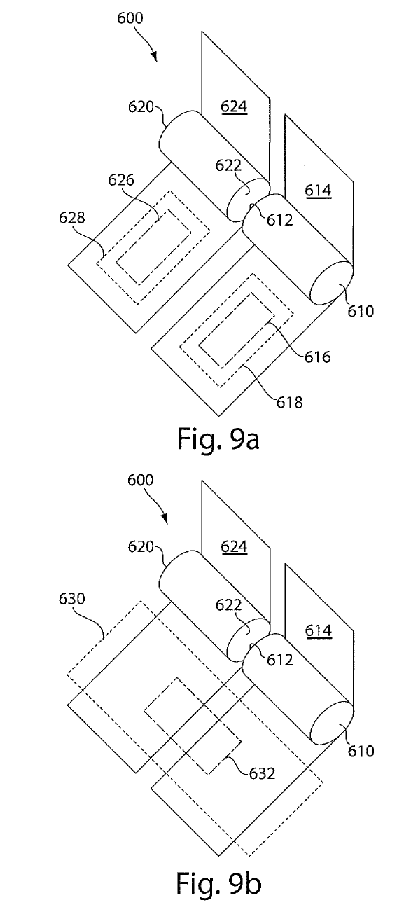

In some implementations, a pressing system may enable the simultaneous application of different foil materials. In such implementations, the pressing system may be configured to press one or more different foils to respective adhesive layers deposited on one or more substrates using multiple adjacent nipping rollers aligned, for example, along respective longitudinal axes of the multiple nipping rollers. Thus, with reference to FIG. 9a, a schematic view of a nip rolling assembly 600 is shown. The nip rolling assembly 600 could be used, for example, in place of the nipping roller 460 and/or the nipping roller 462 depicted in FIG. 7. The nipping roller assembly 600 includes two separate nipping roller 610 and 620 that are positioned adjacent to each other (e.g., placed in an a sequential arrangement along the respective longitudinal axes of the nip rollers) and may be abutting, or nearly abutting, at one of their ends 612 and 622 respectively. Each of the nip rollers 610 and 620 may be similar to any one of the nip rollers shown in FIGS. 2, 4 and 7. The nipping rollers 610 and 620 of the assembly 600 comes in contact with respective foil webs 614 and 624. The webs may be of the same or different materials. The webs 614 and 624 are, in some embodiments, fed from separate spools (not shown in FIG. 9a).

As the foil webs advance underneath the adjacent nip rollers 610 and 620, the nip rollers cause the foils to contact respective adhesive layers 616 and 626 (depicted using dashed-dotted lines) deposited on respective substrates 618 and 628 (depicted using dashed lines). The various adhesives and/or substrates described in relation to FIG. 9a may be similar to the adhesives and/or substrates described in relation to FIGS. 2, 4 and 7. Thus, in some embodiments, the adhesives 616 and 626 may be curable adhesives that become tacky upon application of energy from one or more energy sources (not shown in FIG. 8a) that are positioned past (downstream) the nipping rollers 610 and 620 to avoid, for example, the stretching/warping effects illustrated in FIG. 3. In some embodiments, upstream energy sources (i.e., energy sources located prior to the nip rollers 610 and 620) may be applied to the adhesives to initiate curing, but without causing the adhesives to become tacky. While FIG. 9a shows two adjacent nip rollers, additional nip rollers may be used. The use of multiple adjacent nip roller arrangements may also be implemented in other types of systems in which foil is used, and not only with respect to the systems 200 and/or 400 shown in FIGS. 2 and 7, respectively.

In some embodiments, the assembly of adjacent nip rollers may be applied to a single structure of an adhesive layer deposited on top of a single substrate, as shown, for example, in FIG. 9b, in which the arrangement including the nip rollers 610 and 620 operates on a single substrate 630 (depicted using dashed lines) that is topped with curable adhesive layer 632 (depicted using dashed-dotted lines). The adhesive of the layer 632 may be similar to any of the adhesives described herein, for example, the adhesives 222 and/or 422 shown in FIGS. 2 and 7, respectively. The adhesive layer 632 may be a patterned layered deposited using, for example, a printing device, such as the printing device 210 of FIG. 2. Implementations such as the one shown in FIG. 9b may be used, for example, to place different types of foils on different areas of the adhesive-substrate structure (e.g., foils made of different materials, having different colors or other properties, etc.). In some embodiments, foil may be placed on only one part of a substrate-adhesive structure, while no foil is placed on another part of the substrate-adhesive structure. Such an arrangement of selective foil placement can be implemented, for example, by removing or not using a nip roller when a particular portion of the substrate-adhesive is not to be covered by foil, or alternatively, by not feeding foil to a nip roller contacting a part of the substrate-adhesive that is not to be covered.

A number of embodiments have been described. Nevertheless, it will be understood that various modifications may be made without departing from the spirit and scope of the invention. Accordingly, other embodiments are within the scope of the following claims.

What is claimed is:

1. A method for producing foil relief, the method comprising:
placing a foil on a curable adhesive deposited on a substrate when the curable adhesive is substantially non-tacky; and
applying energy to the adhesive deposited on the substrate while pressing the foil to the adhesive to cause the adhesive to become tacky and to adhere to the foil;
wherein the adhesive becomes substantially fully cured prior to completion of the pressing of the foil to the adhesive deposited on the substrate.

2. The method of claim 1, further comprising:
pre-curing the curable adhesive prior to placing the foil on the adhesive deposited on the substrate to initiate the curing process of the adhesive and manipulate a viscosity level of the curable adhesive, the pre-cured adhesive remaining substantially non-tacky.

3. The method of claim 2, wherein pre-curing the curable adhesive to manipulate the viscosity level of the curable adhesive comprises:
increasing the viscosity level of the curable adhesive.

4. The method of claim 2, wherein pre-curing the curable adhesive comprises:
pre-curing the curable adhesive such that an embossed shape of the curable adhesive is maintained subsequent to completion of the pre-curing.

5. The method of claim 1, wherein applying the energy comprises:
applying energy from one or more of: an ultraviolet radiation source, an electron beam device, a laser device, a non-coherent lamp and a heating element.

6. The method of claim 1, further comprising:
depositing a layer of the curable adhesive on the substrate in a pre-determined pattern prior to the placing of the foil on the adhesive deposited on the substrate.

7. The method of claim 6, wherein depositing the layer of the curable adhesive comprises:
printing the layer of the curable adhesive pattern using on one or more of: inkjet printing, toner-based printing, silk screen printing and lithography printing.

8. The method of claim 1, wherein placing the foil on the adhesive deposited on the substrate comprises:
pressing the foil to the adhesive deposited on the substrate using one or more nipping rollers.

9. The method of claim 8, wherein pressing the foil to the adhesive deposited on the substrate using one or more nipping rollers comprises:
pressing the foil to the adhesive deposited on the substrate using a first set of nipping rollers when the adhesive is substantially non-tacky; and
pressing the foil to the cured adhesive deposited on the substrate using a second set of nipping rollers after applying the energy.

10. The method of claim 1, further comprising:
peeling excess foil.

11. The method of claim 1, wherein the curable adhesive includes one or more of: a radical type adhesive and a cationic adhesive.

12. The method of claim 1, wherein the substrate is made from a material selected from the group of materials consisting of methacrylic copolymer resin, polyester, polycarbonate and polyvinyl chloride.

13. The method of claim 1, further comprising:
increasing flexibility of the foil being placed on the adhesive deposited on the substrate by performing one or more of:
actuating multiple nip rollers used to press the foil to the adhesive deposited on the substrate to move at different rotational speeds; and
applying pressure to the foil.

14. The method of claim 1, wherein placing the foil on the adhesive deposited on the substrate comprises:
pressing one or more different foils to respective adhesive layers deposited on one or more substrates using multiple adjacent nipping rollers aligned along respective longitudinal axes of the multiple nipping rollers.

15. A system for foil relief production, the system comprising:
a pressing machine to press foil to a curable adhesive deposited on a substrate received at an entry stage of the pressing machine when the curable adhesive is substantially non-tacky; and
one or more energy sources to apply energy to the foil pressed to the curable adhesive deposited on the substrate to cause the adhesive to become tacky and adhere to the foil;
wherein the adhesive becomes substantially fully cured prior to the removal of the foil adhered to the substrate from an exit stage of the pressing machine.

16. The system of claim 15, further comprising:
another energy source to apply energy to pre-cure the curable adhesive prior to delivering the curable adhesive deposited on the substrate to the entry stage of the pressing machine, the other energy source configured to initiate the curing process of the adhesive and manipulate a viscosity level of the curable adhesive, the pre-cured adhesive remaining substantially non-tacky.

17. The system of claim 15, further comprising:
a printing device to deposit a pre-determined pattern of the curable adhesive on the substrate.

18. The system of claim 15, wherein the pressing machines comprises:
a first set of nipping roller positioned proximate to the entry stage of the machine to press the foil to the adhesive deposited on the substrate when the adhesive is substantially non-tacky; and
a second set of nipping rollers positioned proximate to the exit stage of the machine to press the foil to the cured adhesive deposited on the substrate after application of energy by the one or more energy sources.

19. A system for the production of foil relief, comprising:
an integrated nipping-curing system, receiving a substrate topped with a patterned layer of curable adhesive, the curable adhesive being non-tacky, said system comprising:
i. means for simultaneously nipping and foil dispensing;
ii. a first radiation emitting means adapted for causing the adhesive to become tacky and for fully curing said foiled and nipped adhesive, located upstream of the end of said nipping means; and;
iii. means for peeling excess foil from adhesive-free surfaces of said cured substrate;
wherein said peeling means is downstream of said full-curing radiation emitting means.

20. A method for applying foil onto a substrate, said method comprising the steps of:
a. providing a system for the production of foil relief, comprising:
i. an integrated nipping-curing system, receiving a substrate topped with a patterned layer of curable adhesive, said adhesive being substantially non-tacky when received by the integrated nipping-curing system; and,
ii. means for peeling excess foil from adhesive-free surfaces of said cured substrate;
b. traversing said adhesive topped substrate through said nipping system;
c. nipping said foil and said substrate thereby bringing said foil into contact with the top side of said adhesive topped substrate;
d. curing said adhesive substantially fully;
e. solidifying the adhesion of said foil to said patterned layer of curable adhesive;
f. peeling the excess of said foil, by peeling foil away from surfaces upon said substrate that have not been patterned with said layer of adhesive, and;
g. producing a relief of foil upon said substrate;
wherein curing said adhesive substantially fully is performed prior to said peeling.
